(19) United States
(12) Patent Application Publication
(10) Pub. No.: US 2022/0114439 A1
(43) Pub. Date: Apr. 14, 2022

(54) METHOD, APPARATUS, AND SYSTEM FOR GENERATING ASYNCHRONOUS LEARNING RULES AND/ARCHITECTURES

(71) Applicant: HERE Global B.V., Eindhoven (NL)

(72) Inventor: Tero KESKI-VALKAMA, Zürich (CH)

(21) Appl. No.: 17/129,464

(22) Filed: Dec. 21, 2020

Related U.S. Application Data
(60) Provisional application No. 63/089,352, filed on Oct. 8, 2020.

(51) Int. Cl. G06N 3/08; G06N 3/063; G06F 9/52

(52) U.S. Cl. CPC G06N 3/08; G06F 9/52; G06N 3/063

(57) ABSTRACT

An approach is provided for generating an asynchronous learning rules and/or architectures. The approach involves, for example, configuring an asynchronous machine learning agent to learn based on machine learning tasks. The asynchronous machine learning agent includes agent inputs for inputting task inputs of the machine learning tasks, agent outputs for outputting task outputs of the machine learning tasks, task feedback signals for scoring a performance on the one or more machine learning tasks, and a stateful neural units that are arbitrarily connected. The approach also comprises initiating a training of the asynchronous machine learning agent to learn an agent architecture, an agent learning rule, or a combination thereof based on the machine learning tasks. The approach further comprises configuring the stateful neural units based on the agent architecture, the agent learning rule, or a combination thereof to perform a subsequent machine learning task.

### RELATED APPLICATION

This application claims priority from U.S. Provisional Application Ser. No. 63/089,352, entitled “METHOD, APPARATUS, AND SYSTEM FOR GENERATING aSYNCHRONOUS LEARNING RULES AND ARCHITECTURES,” filed on Oct. 8, 2020, the contents of which are hereby incorporated herein in their entirety by this reference.

### BACKGROUND

Asynchronous neural network architectures, such as those employed by neuromorphic chips, promise to vastly decrease the power consumption requirements of machine learning. Realizing this promise has been difficult because finding learning rules and architectures that are optimized for asynchronous neural networks is technically challenging. Consequently, asynchronous networks such those found in neuromorphic computation architectures and corresponding hardware (e.g., computer chips) can be further optimized for speed and efficiency.

### SOME EXAMPLE EMBODIMENTS

Therefore, there is a need for an approach for generating asynchronous machine learning rules and/or architectures.

According to one embodiment, a method comprises configuring an asynchronous machine learning agent to learn based on one or more machine learning tasks. The asynchronous machine learning agent, for instance, includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected (e.g., neural units of a neuromorphic chip or equivalent). The method also comprises initiating a training of the asynchronous machine learning agent to learn an agent architecture, an agent learning rule, or a combination thereof based on the one or more machine learning tasks. The method further comprises configuring the plurality of the stateful neural units based on the agent architecture, the agent learning rule, or a combination thereof to perform a subsequent machine learning task.

According to another embodiment, an apparatus comprises at least one processor, and at least one memory including computer program code for one or more computer programs, the at least one memory and the computer program code configured to, with the at least one processor, cause, at least in part, the apparatus to configure an asynchronous machine learning agent to learn based on one or more machine learning tasks. The asynchronous machine learning agent, for instance, includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected. The apparatus is also caused to initiate a training of the asynchronous machine learning agent to learn an agent architecture, an agent learning rule, or a combination thereof based on the one or more machine learning tasks. The apparatus is further caused to configure the plurality of the stateful neural units based on the agent architecture, the agent learning rule, or a combination thereof to perform a subsequent machine learning task.

According to another embodiment, a non-transitory computer-readable storage medium carries one or more sequences of one or more instructions which, when executed by one or more processors, cause, at least in part, an apparatus to configure an asynchronous machine learning agent to learn based on one or more machine learning tasks. The asynchronous machine learning agent, for instance, includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected. The apparatus is also caused to initiate a training of the asynchronous machine learning agent to learn an agent architecture, an agent learning rule, or a combination thereof based on the one or more machine learning tasks. The apparatus is further caused to configure the plurality of the stateful neural units based on the agent architecture, the agent learning rule, or a combination thereof to perform a subsequent machine learning task.

According to another embodiment, an apparatus comprises means for configuring an asynchronous machine learning agent to learn based on one or more machine learning tasks. The asynchronous machine learning agent, for instance, includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected. The apparatus also comprises means for initiating a training of the asynchronous machine learning agent to learn an agent architecture, an agent learning rule, or a combination thereof based on the one or more machine learning tasks. The apparatus further comprises means for configuring the plurality of the stateful neural units based on the agent architecture, the agent learning rule, or a combination thereof to perform a subsequent machine learning task.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating asynchronous machine learning rules and/or architectures, according to one embodiment;

FIG. 2 is a diagram illustrating an example of a learned asynchronous machine learning network architecture, according to one embodiment;

FIG. 3 is a diagram illustrating an example of a neural unit configured with a learned machine learning rule, according to one embodiment;

FIG. 4 a flowchart of a process for configuring an asynchronous learning agent to generate asynchronous machine learning rules and/or architectures, according to one embodiment;

FIG. 5 is a flowchart of a process for selecting machine learning tasks to train a machine learning agent to generate asynchronous machine learning rules and/or architectures, according to one embodiment;

FIG. 6 is a flowchart of training a machine learning agent to generate asynchronous learning rules and/or architectures using reinforcement learning, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal that can be used to implement an embodiment of the invention.

### DESCRIPTION OF SOME EMBODIMENTS

Examples of a method, apparatus, and computer program for generating asynchronous machine learning rules and/or architectures are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

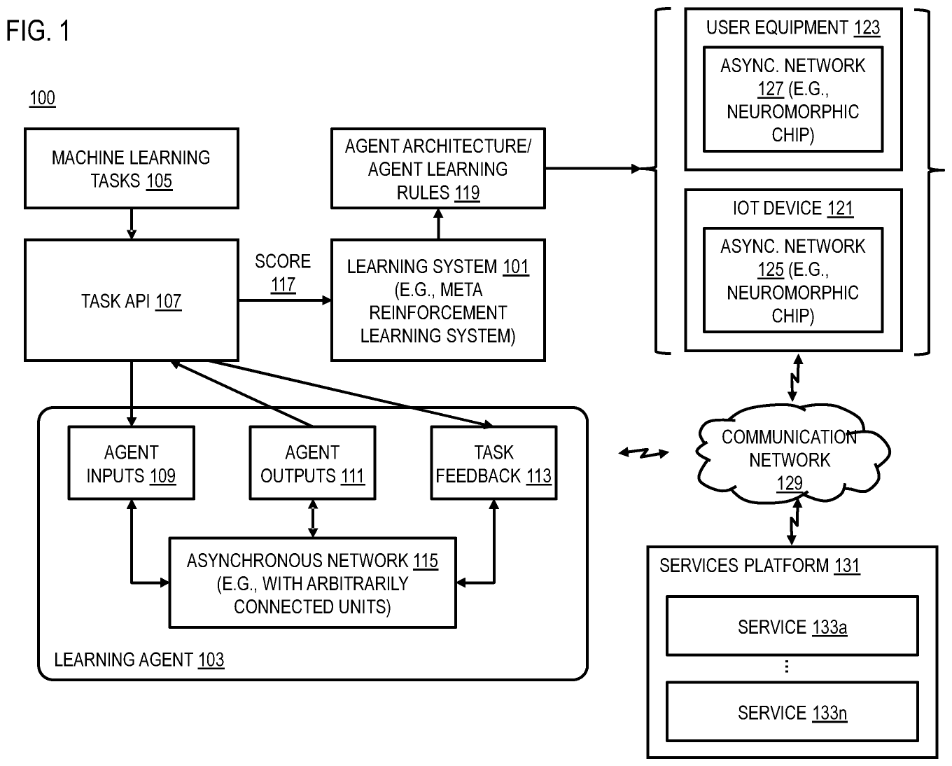

FIG. 1 is a diagram of a system capable of generating asynchronous machine learning rules and/or architectures, according to one embodiment. Asynchronous neural architectures, including but not limited to bioinspired neuromorphic computation architectures have a promise of vastly decreasing power consumption requirements of neural machine learning by exploiting the sparseness of information. For example, in many machine learning applications the data or information being processed is generally sparse in the sense that many feature values that are being processed by machine learning systems are zero values or equivalent. Features values, for instance, are the measurable or extractable properties or characteristics being observed for processing by a machine learning system. These features are generally converted to a vector/matrix representation where absent or null value features are recorded as zeros. In many cases, the vectors have a relatively high ratio of zero or null values compared to non-zero feature values, thereby resulting in a high level of data sparsity.

Traditional synchronous machine learning systems historically have not directly accounted for data sparsity. As a result, synchronous systems can potentially waste compute cycles performing mathematical compute operations of zero values (e.g., multiplying 0 by 0). In contrast, asynchronous systems are able to advantageously avoid performing such zero-value operations to reduce compute cycle usage and associated power consumption. In addition, the increased parallel processing architecture of asynchronous neural networks (e.g., by avoiding having to wait for one compute process or task to complete before beginning another) provides for increase speed and efficiency of machine learning system development.

For example, recent developments in neuromorphic computer chip designs enable neuromorphic systems to perform on-chip processing asynchronously. Neuromorphic chips more closely model biological brains by using an event driven approach known as a “spike train” that encodes data in a temporal domain. Under this approach, neural units of the neuromorphic chips are active and consume power on demand instead of continuously consuming power (even in an idle state) as traditional processing or tensor cores in Graphics Processing Units (GPUs) or Tensor Processing Units (TPUs) currently do.

However, because of the asynchronous nature and event-driven approach of asynchronous neural network systems, it is a significant technical challenge to find learning rules and architectures which are able to match or exceed traditional normal deep learning performance in machine learning in the asynchronous domain. For example, current asynchronous neural systems are mainly neuromorphic and bioinspired and, as a general rule, follow the Hebbian learning rules such as spike-time-dependent plasticity (STDP) and their variants observed in biological neurons. These bioinspired approaches, for instance, simulate electrical voltage dynamics in neurons and have some limited success in exhibiting learning, but these approaches have not currently matched the power of traditional tensor-based deep learning. In many cases, developers manually code, configure, or discover these bioinspired approaches, which restricts the search space for effective and efficient asynchronous alternatives.

To address these technical challenges, a system 100 of FIG. 1 introduces a capability to automatically generate asynchronous machine learning rules and/or architectures using a training platform (e.g., learning system 101 such as, but not limited to, a meta reinforcement learning system) in combination with a meta-structure of an asynchronous learning agent (e.g., learning agent 103). In one embodiment, the system 100 uses an environment that consists of arbitrary machine learning challenges or tasks 105 of different machine learning types (e.g., object recognition, speech processing, classification, natural language processing, learning-based gaming, etc.). The machine learning types include, but are not limited to, supervised, unsupervised, reinforcement, or any other type of traditional machine learning types known in the art.

As shown, in one embodiment, a programmatic interface (e.g., a task application programming interface (API) 107) is provided to feed inputs from the machine leaning tasks 105 to one or more agent inputs 109 of the learning agent 103 for training/optimizing the asynchronous network 115 of the learning agent 103. By way of example, the asynchronous network 115 can be any asynchronous, parameterized internal network with arbitrarily connected stateful neural units. Examples of an asynchronous network 115 include but are not limited to the neural units of a neuromorphic chip or equivalent. The neural units, for instance, are arbitrarily connected in the sense that the each neural unit of the network 115 can be connected to any number of other neural units via an input or output signal. The connections between any two neural units are configurable to exist or not exist. In addition, the neural units can be configured to be any type of neural unit including but not limited to an input unit (e.g., a neural unit that accepts an input into the network 115), an output unit (e.g., a neural unit produces an output of the neural network), a reward unit (e.g., a neural unit associated with reinforcement learning reward/scoring), a hidden unit (e.g., a neural unit that is in a hidden or fully connected layer of the network 115), or any other configurable neural unit type known in the art.

In one embodiment, the task API 107 also reads outputs from one or more agent outputs 111. The outputs of the agent outputs 111, for instance, are output signals generated by the asynchronous network 115 in response to the inputs provided through the agent inputs. For example, the asynchronous network 115 can use the inputs to change or modify its internal state parameters, e.g., specifying its neural unit type and/or connections to other neural units (i.e., its architecture) and/or specifying how it handles input signals to generate output signals (i.e., its learning rules). The task API 107 can also generate task feedback signals 113 (e.g., reinforcement learning rewards) based on the outputs to indicate the performance of the asynchronous network 115 on the assigned machine learning tasks 105 with respect to network 115's currently configured architecture and/or learning rules.

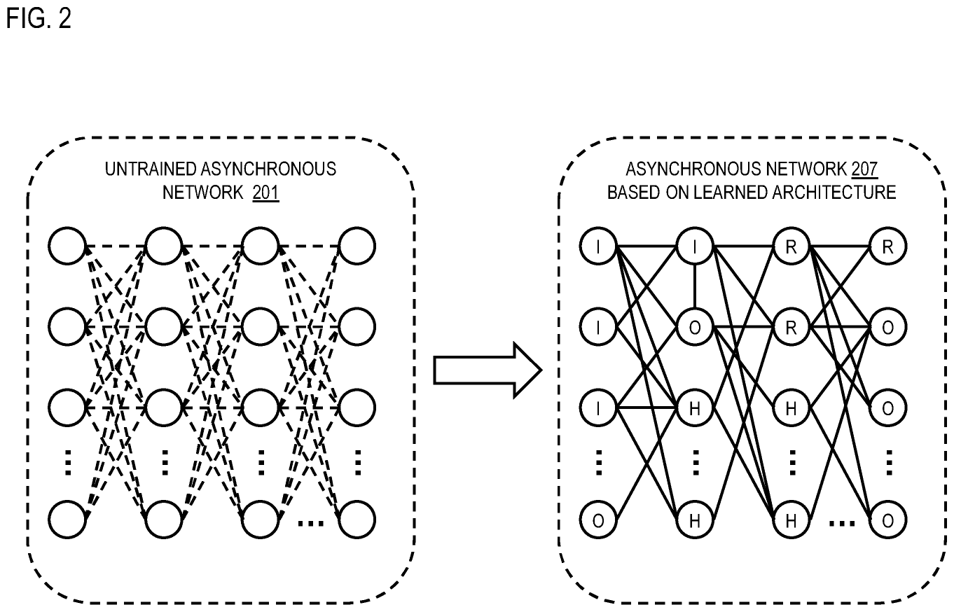

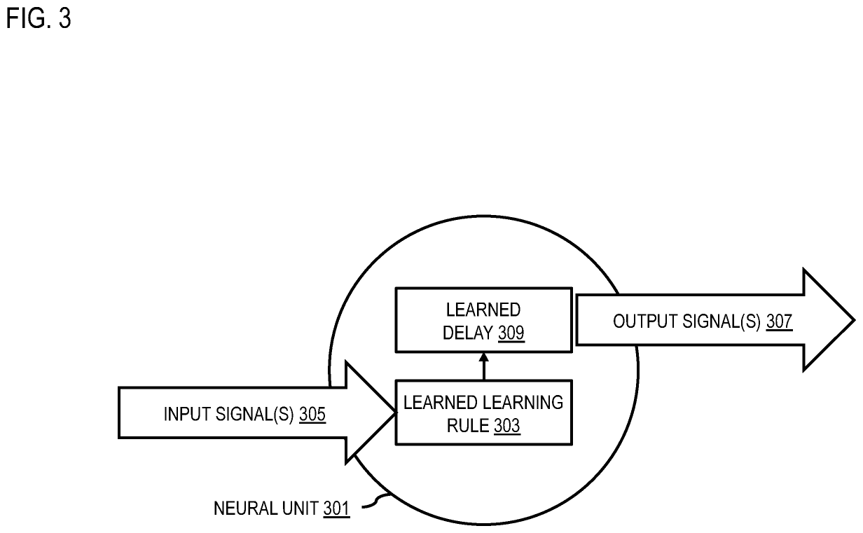

In one embodiment, the task API 107 can also use the feedback signals 113 to generate a score 117 associated with the performance of the learning agent 103 or the asynchronous network 115 of the learning agent 103. The learning system 101 can use the score 117 as an input into a meta-reinforcement learning algorithm to determine whether continued training/optimizing of the current architecture/learning rules of the asynchronous network 115 is to be performed or whether the current state of the learned architecture (e.g., discussed in more detail with respect to FIG. 2 below) and/or learning rules (e.g., discussed in more detail with respect to FIG. 3 below) should be output as the agent architecture and/or agent learning rules 119. The reinforcement learning of the learning system 100 is referred to as “meta-reinforcement” indicate that the reinforcement learning is being performed on the asynchronous network 115 which itself is be optimized to be able to learn how learn machine learning tasks 105 of different types. In other words, the meta-reinforcement learning of the learning system 101 optimizes the asynchronous architecture and/or learning rules or an asynchronous network 115 (e.g., a network of neural units of a neuromorphic chip) to be able to learn different types of different tasks as opposed to training the asynchronous network 115 to learn any one specific machine learning task 105.

The resulting learned agent architecture and/or learned agent learning rules 119 is thus optimized for learning subsequent machine learning tasks of any type (e.g., any learning type on which the learning agent was optimized) while providing for the power consumption and efficiency advantages of neural networks. When compared to the traditional approach of using bioinspired architectures and/or learning rules (e.g., Hebbian learning rules), the embodiments of the learning approach to generating asynchronous architectures and/or learning rules are not limited to bioinspired models, and can potentially result in architectures and/or learning rules not previously known, explored, or with parallels to any other known system.

By increasing the search space for new asynchronous architectures and/or learning rules, the system 100 advantageously enables discovering many different learning rules and/or architectures which can enable the system 100 to bring the power of current deep learning systems to an synchronous domain in a general fashion. These new asynchronous learning rules and/or architectures can potentially exceed the performance and efficiency of traditional bioinspired Hebbian learning rule performance, and allow the system 100 to run powerful asynchronous machine algorithms in spatio-temporally sparse computing substrates and architectures. In another embodiment, the system 100 can run these power asynchronous machine learning algorithms in resource and/or power constrained devices such as but not limited to an Internet of Things (IoT) device 121 and user equipment (UE) devices 123 (e.g., mobile devices such as but not limited to smartphones). For example, the IoT device 121 and/or UE 123 may be equipped with respective asynchronous networks 125 and 127. The system 100 can then configure the networks 125 and/or 127 over, for instance, a communication network 129 or equivalent to operate using the optimized agent architecture/agent learning rule 119. In another use case, the optimized agent architecture/agent learning rules 119 can also be transmitted over the communication network 129 to a services platform 131 and/or any of its services 133a-133n (also collectively referred to as services 133).

FIG. 2 is a diagram illustrating an example of a learned asynchronous machine learning network architecture, according to one embodiment. In the example of FIG. 2, an untrained asynchronous network 201 includes a network of neural units (indicated by circles). As discussed above, the neural units can be connected arbitrarily to any other neural unit with connections indicated by the dash lines. The neural units can also be configured to act as any type of neural unit of any of the network types (e.g., supervised, unsupervised, reinforcement, etc. network types). These unit types include, but are not limit to, input neural units for accepting network inputs, output neural units for output network outputs, reward neural units for scoring network performance for reinforcement learning, hidden neural units for neural processing in the network, etc.

The system 100 can include the network 201 in a meta-learning structure of a learning agent 103 along with agent inputs or interface 109, agent outputs or interface 111, and task feedback signals or interface 113 for interacting with the programmatic interface of task API 107 and learning system 101 to generate a trained or optimized asynchronous architecture 203 according to the embodiments described herein. As shown, the optimized asynchronous network 203 is configured based on the architecture learned by the learning agent 103 in combination with the learning system 101. In one embodiment, the learned or optimized architecture defines the connections between neural units as well as the unit type of each. The architecture, for instance, can be encoded in the internal state parameters associated with each neural unit such that, for instance, the parameters specify the other neural unit(s) to which the output signals (and/or input signals) of the neural unit is connected and a code/flag indicating the neural unit type. In this example, the optimized architecture 203 is illustrated with neural units represented by circles in which the neural type of each is indicated by an “I” to indicate an input unit, “O” to indicate an output unit, “R” to indicate a reward unit, and “H” to indicate a hidden unit. Connections between each neural unit is indicated by solid lines. The asynchronous architecture 203 represents the assignment of neural unit types and connections among individual neural units of an asynchronous neural network that are predicted to facilitate performing subsequent machine learning tasks of the types on which the learning agent was trained.

In one embodiment, in addition to the optimized or learned architecture, the system 100 can generate asynchronous learning rules for the neural units of the asynchronous network. FIG. 3 is a diagram illustrating an example of a neural unit configured with a learned machine learning rule, according to one embodiment. As shown, each a neural unit 301 includes a learned or optimized learning rule 303 that determines how the neural unit 301 will receive and process one or more input signals 305 to generate one or more output signals 307 to the one or more other neural units as indicated by learned architecture (e.g., the architecture 203 of FIG. 2). In one embodiment, the neural unit 301 can also be configured with a learned delay 309 that can be applied before the output signals 307 are forwarded from the neural unit 301. The learning rules are indicated by internal state parameters of the neural unit 301 according to the embodiments described herein.

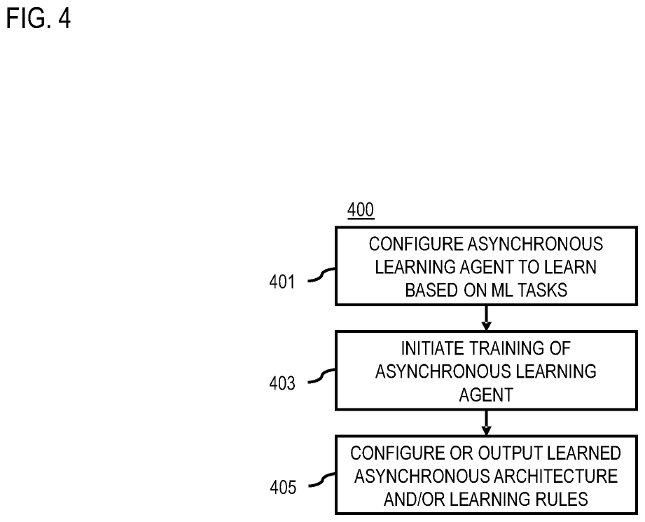

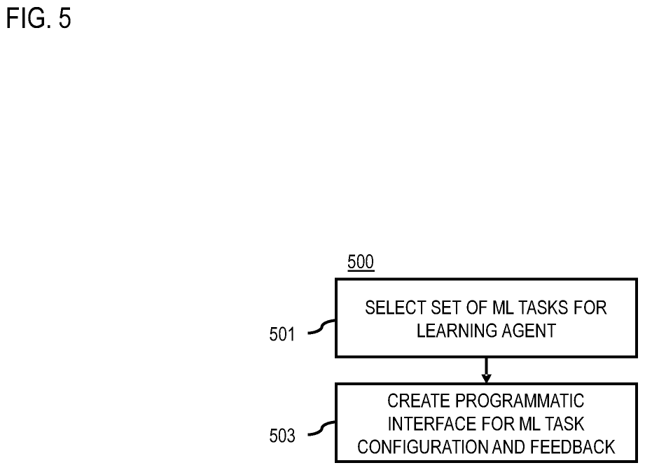

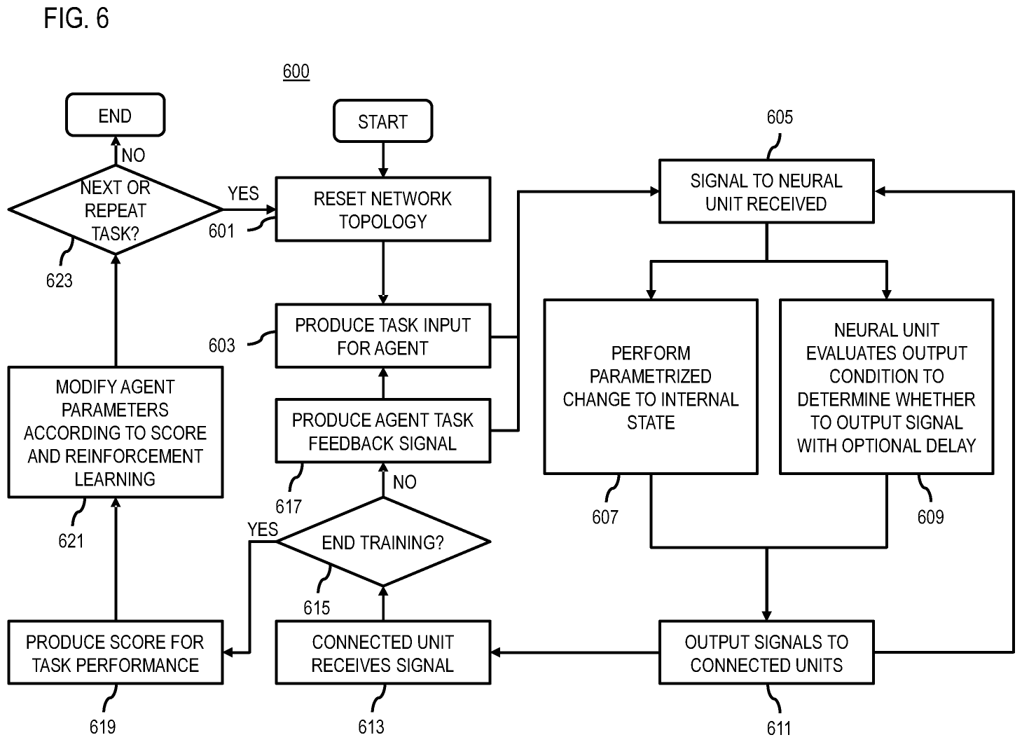

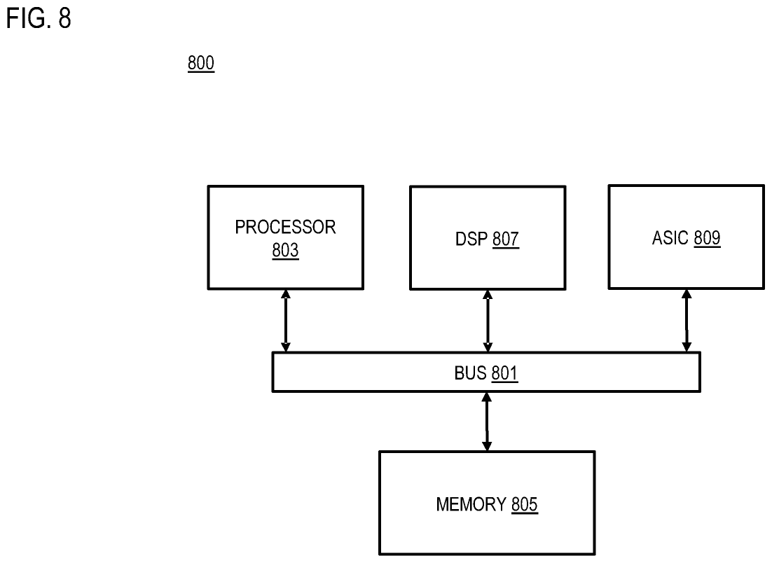

The processes for generating asynchronous machine learning architectures and/or rules are discussed in more detail with respect to FIGS. 4-6. FIG. 4 a flowchart of a process for configuring an asynchronous learning agent to generate asynchronous machine learning rules and/or architectures, according to one embodiment. In one embodiment, the learning system 101 alone or more in combination with the learning agent 103 and the task API 107 may perform one or more portions of the process 400 and may be implemented in, for instance, a chip set including a processor and a memory as shown in FIG. 8. As such, the learning system 101, learning agent 103, and/or task API 107 can provide means for accomplishing various parts of the process 400. Although the process 400 is illustrated and described as a sequence of steps, it is contemplated that various embodiments of the process 400 may be performed in any order or combination and need not include all of the illustrated steps. The process 400 is discussed with respect to the process 500 of FIG. 5 and the process 600 of FIG. 6.

At process 401, the learning system 101 interacts with the task API 107 to configure the asynchronous machine learning agent 103 to learn based on one or more machine learning tasks 105. As discussed above, in one embodiment, the asynchronous machine learning agent 103 includes one or more agent inputs 109 for inputting one or more task inputs of the one or more machine learning tasks 105, one or more agent outputs 111 for outputting one or more task outputs of the one or more machine learning tasks 105, one or more task feedback signals 113 for scoring a performance on the one or more machine learning tasks 105, and a plurality of stateful neural units that are arbitrarily connected (e.g., neural units of an asynchronous network 115 such as neural units of a neuromorphic chip). In one embodiment, the environment of the process 400 used for meta-reinforcement learning to generate asynchronous architectures and/or learning rules 119 consists of a set of tasks (e.g., machine learning tasks 105). These tasks 105 are defined based on their interface (e.g., the task API 107) to the learning agent 103 (e.g., agent inputs 109, agent outputs 111, and task feedback signals 113 of the learning agent 103).

For example, as shown in the process 500 of FIG. 5, at process 501, a set of general machine learning tasks 105 can be selected for training or optimizing of the learning agent 105. These machine learning tasks 105 can be of supervised, unsupervised, reinforcement, and/or other any other machine learning type. By selecting different learning types, the generated asynchronous architecture and/or learning rules 119 can be optimized to learn across the selected different learning types. For example, training the learning agent 103 all three supervised, unsupervised, and reinforcement learning types, can result in an asynchronous network 115 with an architecture and/or learning rules that is optimize a machine learning task of any of those three learning types. In other words, the generated architecture and/or learning rules enables an asynchronous network 115 to learn how learn the machine learning tasks of those types. At process 503, a programmatic interface (e.g., the task API 107) is created for the set of general tasks selected at process 501 which the learning agent 103 can use to dynamically answer to the challenge and receive feedback. In addition, the programmatic interface can be used to provide a task score 117 representing the learning agent 103's performance on the selected machine learning tasks 105 to the learning system 101 for reinforcement learning.

At process 403, the learning system 101 alone or in combination with the task API 107 initiates a training of the asynchronous machine learning agent 103 to learn an agent architecture, an agent learning rule, or a combination thereof (e.g., agent architecture/agent learning rules 119) based on the selected one or more machine learning tasks 105. For example, in a supervised machine learning task 105, the learning agent 103 is given training examples of inputs, its outputs are read, and it is given the error for each of its output components. The training examples are conveyed through the programmatic interface of the task API 107 to the agent input interface 109 of the learning agent, the output is conveyed from the agent output interface 111 of the learning agent to the task API 107, and the error is conveyed from the task API 107 to the feedback signal interface 113.

In unsupervised machine learning tasks, the system is given a set of data through inputs, and after an arbitrary, task-dependent time the output is interpreted as, e.g., clustering, and scored based on how good that clustering is. In other words, unsupervised machine learning tasks 105 generally include clustering of unlabeled inputs, with no ground truth data against which the output can be compared. Thus, evaluation of supervised learning performance depends on the quality of the clustering against designated clustering metrics. The set of data can be conveyed through the programmatic interface of the task API 107 to the agent input interface 109, the unsupervised output (e.g., clustering results) can be conveyed from the agent output interface 109 to the task API 107, and the assessment of the quality of the clustering can be conveyed from the task API 107 to the feedback signal interface 113.

In reinforcement machine learning tasks, the system is given inputs and rewards, the actions are read out, and the ultimate performance of the system in that task is again scored. Reinforcement learning, for instance, varies the architecture/learning rules of asynchronous network 115 of the learning agent 103 to process the input to generate an output. The output is evaluated against reward criteria, and rewards are provided based on the performance of the learning agent 103 in generating the output. The reward incentivizes the use a similar architecture/learning rule when encountering a similar input again. The given inputs can be conveyed from the task API 127 to the agent input interface 109, the outputs can be conveyed from agent output interface 111 to the task API 127, and the rewards can be conveyed from the task API 127 to the task feedback interface 113.

In one embodiment, the task API 107 can generate a score 117 representing the learning agent's performance in executing the machine learning tasks 105 in the end. The score is used in a meta-reinforcement learning architecture where the system 101 optimizes the learning agent 103's architecture and learning rules to create an agent 103 which is able to perform supervised, unsupervised and reinforcement learning for any tasks.

In one embodiment, the learning agent 103 is structured in an asynchronous fashion so that it has a set of arbitrarily connected neural units, which are able to activate upon receiving an input signal, perform neural processing on that signal, modify its internal state, and send forward zero or more immediate or delayed signals to other units or to itself. By activating on receiving the input signal, the neural unit advantageously reduces power consumption by remaining inactive (and drawing little to no power) unless the unit is processing a signal.

The neural unit inputs receive arbitrary sized tensors, and these tensors are used along with the unit's internal state to compute the next internal state, and the set of output signals consisting of target, signal content (a tensor), and a delay which can be zero. These neural units can be neural networks, or any other parametrized models which can be optimized or trained by the reinforcement learning meta-optimizer. In one embodiment, the computing or neural units have identical/symmetric learning rules which are learned over many general machine learning tasks 105.

In effect, the embodiments of reinforcement learning techniques are used here to train rules which are able to learn in supervised, unsupervised, reinforcement, and/or other machine learning contexts in asynchronous computing architectures. Embodiments of the reinforcement learning techniques are described in more detail with respect to FIG. 6.

FIG. 6 is a flowchart of training a machine learning agent to generate asynchronous learning rules and/or architectures using reinforcement learning, according to one embodiment. Beginning at process 601, the first step of training should allow the system to self-organize its topology by a reset protocol. In reset, the asynchronous units which are read as outputs are given a designated tensor signal to inform them of this, and a different tensor signal is given to units which are to be treated as inputs in the task, and in reinforcement learning context, a yet different tensor signal is given to the units which are to receive rewards during the task. The units therefore have an opportunity to learn to discover their topological relations to these external interfaces, which they can use to specialize in their roles by changing their internal states accordingly before the task actually begins.

In other words, the process 600 of training or optimizing the learning agent 103 (e.g., incorporating an asynchronous network) to learn to learn, as to generate asynchronous learning rules and/or architectures, may begin by initializing a network reset procedure 601 to produce a parameterized network with arbitrarily connected stateful units. This reset procedure 601 initializes a topology of the network 115 of agent 103. Topology reset 601 may include sending random signals to the network 115 of agent 103. Processing these random signals provides neural units of agent 103 to learn their topological relations based on external interfaces. When the network 115 of agent 103 is employed on asynchronous hardware such as a neuromorphic chip, for instance, processing these signals may allow the agent 103 to identify neural units closest (or with minimal latency) to the bus and/or other structure connecting the CPU, memory, and/or other components together. A portion of these close units may be assigned as input neural units and/or output neural units. Topology reset 601 may also comprise sending an input tensor signal designating a first portion of the units as input units and/or an output tensor signal designating a second portion of the units as output units. If a reinforcement learning task 105 is also selected to be used by task API 107 to train the network 115 of the agent 103, a reinforcement tensor signal may be sent designating another portion of the units as reward receiving units. Other types of neural units may also be initialized using a corresponding tensor signal in an analogous fashion.

After initializing the topology of the network 115 of agent 103, task API 107 produces one or more task inputs and provides them to the agent 103 through the agent inputs 109, as shown at process 603. The task inputs may be sent separately or interlaced. Regardless of how sent, the task inputs induce sending a signal to the input neural units within agent 103 (e.g., determined during the network topology reset 601), as shown at process 605. The signal receiving unit can then perform a parameterized change to its internal state at process 607. For example, the neural unit can perform the internal state change according to the following:
state:=STATE(state,signal;state_parameters)
   where the STATE function takes the current internal state of the neural unit (state), the received input signal (signal), and state parameters (state_parameters) to update the internal state (e.g., representing changes to its architecture and/or learning rules being applied).

In addition or alternatively, at process 609, the neural unit receiving the input signal can evaluate an output condition to determine whether to generate an output signal including whether to add a delay to outputting the signal. For example, to generate the output signal, the neural evaluates a Boolean valued output condition:
output:=OUTPUT (state, signal;output_parameters)
   where the OUTPUT function takes the current internal state of the neural unit (state), the received input signal (signal), and output parameters (state_parameters) to determine whether an output should be performed (e.g., indicated by a Boolean value for output where 0=no output and 1=affirmative output).

In one embodiment, if the output condition signifies affirmative, the neural unit also signals other neural units to which it has output connections by sending the connected units a signal with an optional time delay specified based on the following but not exclusive example:
(output_signal,output_signal_delay):=SIGNAL(state, signal:signal_parameters)
   where the output_signal is the signal that is to be output, output_signal_delay is the delay time, SIGNAL is the function to determine the delay for the output signal based on the current internal state (state) of the neural unit (state) and the received input signal (signal).

After changing internal state and/or activating in threshold dependent manner, the unit sends output to all units which are referenced by output connections at process 611. In one embodiment, the unit sends an input signal to all units having a connectivity tensor including a connection to the activated or state changed unit.

At process 613 an agent output 111 (e.g., with a connection to the neural units) receives the output signal generated by the receiving unit at process 613. The output can be used to determine whether to end the training of the learning agent 103 on the current machine learning task 105 at process 615. For example, the output can be evaluated against ending criteria (e.g., target accuracy achieved, unsupervised learning stop period has been reached, etc.) to determine whether to end training. If training on the current machine learning task 105 is not to end, the task API 107 generates a feedback signal based on the output signal and passes it to the agent 103 via task feedback 113 at process 617. Utilizing the feedback signal 113, the agent 103 initiates an update or modification of the internal state (e.g., state parameters associated with a current architecture—e.g., connections, neural unit type, etc.—or learning rule) of one or more neural units and returns to process 605.

At process 619, if the training on the current machine learning task 105 has ended, task API 107 produces a score for the task performance. In one embodiment, the score is calculated based on the machine learning task type. For example, for supervised learning task, the score can be based one error with respect to ground truth; for unsupervised learning, the score can be based on quality of clustering; and for reinforcement learning, the score can be based on achieved rewards. In other use cases, the score may be based on training cost functions. For example, the score may be dependent upon the power consumed when performing and/or learning the task, the heat generated when performing and/or learning the task, the number of computations required to perform and/or learn the task, the accuracy of task performance, and/or other indicators of the efficiency and/or accuracy of the agent. The score generated by task API 107 indicating task performance after training is sent to meta reinforcement learning system 101, which uses the score in a reinforcement learning algorithm to modify the parameters of agent 103 according to the achieved score at process 621. The action taken within the reinforcement learning algorithm is modifying the parameters of the network 115 of agent 103. Accordingly, meta reinforcement learning system 101, accordingly, may choose to take an action involving changing at least one of the topology of the network 115 of agent 103, state_parameters of the units of network 115 of agent 103, and/or learning rules. The meta reinforcement learning employed thus comprises adjusting at least one of the learning rule, the topology of the tensor network, and a state parameter of at least one unit of the plurality of units based on the scoring using reinforcement learning.

The action taken during meta reinforcement learning by learning system 101 may be to alter a state parameter of at least one of the units within the network 115 of agent 103. The state parameters a unit may include bias, delay, a connectivity tenser, and/or any other parameter, other than a weight tensor, affecting the state of a unit in response to an input. While elements of a weight tensor are utilized in many state functions to determine the state of unit in response to an input, adjusting weights is part of learning a task. As such, adjusting the weights of the network 115 occurs when task API 107 trains the network to learn the task. Because the embodiments described are concerned with learning a architectures and/or rules for learning how to learning tasks of different learning types instead of specific task, meta reinforcement learning system 101 may adjust the elements of the network 115 of agent 103 not changed when trained to learn a task.

One such state parameter may be bias of the units. Accordingly, the action taking during meta reinforcement learning may be to change the bias of one or more of the units of network 115 of agent 103. Another such state parameter may be delay of the units. Accordingly, the action taken during meta reinforcement learning may be to change the delay of one or more of the units. The delay, for instance, enables the network 115 to approximate the synaptic firing cascade observed in biological systems.

The connectivity tensor may be another state parament not changed when API 107 trains the network 115 of agent 103 to learn task. When learning a task, the weight tensors are adjusted in accordance with a learning rule. As a result of the adjustment, weight may be set to zero or such a small number that value of weight is practically zero. Having a zero and/or practically zero weight, however, does not remove the connection from the connectivity architecture of the network 115 of agent 103. Even though signals received from the connection will have no, or very little, impact on the state of the unit, the connection is still present. As such, the signal received by the connection is multiplied by the weight and the product added to the summed total weighted input received by the unit. The connection, therefore, still produces computations which consume power and/or generate heat. An action taken by meta reinforcement learning system 101 during meta reinforcement learning may, therefore, be to remove connections having weights below a threshold. Accordingly, in some embodiments meta reinforcement learning may comprise altering the connectivity tensor of at least one unit of the network 115 of agent 103 to remove a connection.

During meta reinforcement learning, taking the action of altering the connectivity tensor of a unit to remove a connection may be performed to alter the topology of the network 115 of agent 103. The connectivity tensors of the neural units define at least a portion of the topology of the network 115 of agent 103. For example, if a unit is connected to an input layer of the network 115 of the agent 103, the connectivity tensor of the unit will have at least one connection to at least one unit in the input layer. Conversely, if a unit is not connected to an input layer, its connectivity tensor will lack connections to any unit in the input layer. An output layer, for example, may not be connected directly to an input layer, but rather through a hidden layer. This separation between input layer and output layer can be reflected in the connectivity tensors of all units of the output layer lacking connections to any unit of the input layer. In another example, the output layer could be further separated from the input layer by a second hidden layer. For the network 115 of agent 103 to develop such a topology during meta reinforcement learning, the connectivity tensor of at least one unit of hidden layer would have to be altered to remove all connections to the units of the input layer and have at least one connection to another unit within hidden layer. Additionally, the connectivity tensors of the units of the output layer would have to be altered to remove all connections with the hidden layer and replace them with new connections to the unit or units disconnected from input layer and connected to other units of hidden layer. Altering the connectivity tensors of one or more units of the hidden layer and the connectivity tensors of the output layer in such a manner would alter the topology of the network 115 of agent 103 to have second hidden layer in addition to hidden layer. In addition to splitting units into new layers, the meta reinforcement learning system 101 may alter the connectivity tensor of unit as to remove the unit from the network by removing all connections between the unit and other units within the network 115. Accordingly, by altering the connectivity tensors of the units within the network 115 of agent 103, the meta reinforcement learning may alter the topology of the network 115 of agent 103. Accordingly, during meta reinforcement learning, the topology of the network 115 of agent 103 may be altered to remove units, hidden layers, and/or move units between layers.

The action taken during meta reinforcement learning may comprise adjusting the learning rule to change how a neural unit receives and processes an input signal to generate an output signal. For example, the change can include changing internal state_parameters of the neural unit that affects the conditional Boolean function used for determining whether output a signal and with what amount of delay.

At process 623, the learning system 101 interacts with the task API 127 to determine whether there is another selected machine learning task to complete or whether the just completed machine learning task is to be repeated. If either condition is true, the learning system 101 returns to process 601 to initiate a network topology reset according the embodiments described above to train on the next machine learning task or repeat the just completed learning task to continue the meat-reinforcement learning process. If there is no next task or the current task is not to be repeated, the meta-learning reinforcement learning process is completed.

The current state of the asynchronous architecture and/or learning rules can then be generated or provided as the agent architecture/agent learning rule 119. Returning to process 405 of FIG. 4, after the asynchronous learning rules and/or architecture is generated, the learning system 101 and/or learning agent 103 can the plurality of the stateful neural units of an asynchronous network based on the learned agent architecture, the learned agent learning rule, or a combination thereof to perform a subsequent machine learning task (e.g., of any learning type on which the architecture or learning rules were trained).

In one embodiment, the agent architecture/agent learning rule 119 are represented the collective internal states of the neural units of the asynchronous network 115 of the learning agent 103. The internal states generally can be represented as tensors or matrices which can be serialized for storage, transmission, and/or configuration of the same network 115 or other asynchronous networks of neural units. For example, the learned asynchronous architecture and/or learning rules can be generated on a cloud component and then instantiated in IoT devices 121 and/or UEs 123 equipped with neuromorphic chips or equivalent.

Returning to FIG. 1, in one embodiment, the generated asynchronous machine learning rules and/or architectures can be used for a range of services and applications. For example, machine learning enables a range of new services and functions including for applications such as autonomous driving, robotic systems, and/or the like. For example, with respect to autonomous driving, computer vision and computing power supporting feature detection and other related machine learning techniques have enabled real-time mapping and sensing of a vehicle's environment. Such an understanding of the environment enables autonomous, semi-autonomous, or highly assisted driving in a vehicle (e.g., a vehicle 101) in at least two distinct ways.

First, real-time sensing of the environment provides information about potential obstacles, the behavior of others on the road, and safe, drivable areas. An understanding of where other cars are and what they might do is critical for a vehicle to safely plan a route. Moreover, vehicles generally must avoid both static (lamp posts, e.g.) and dynamic (cats, deer, e.g.) obstacles, and these obstacles may change or appear in real-time. Thus, detecting such objects in image data collected by the vehicles (e.g., via an asynchronous machine learning architecture and/or learning rules determined according to the embodiments described herein) can support such functionality. More fundamentally, vehicles can use a semantic understanding of what areas around them are navigable and safe for driving. Even in a situation where the world is completely mapped in high resolution, exceptions will occur in which a vehicle might need to drive off the road to avoid a collision, or where a road's geometry or other map attributes like direction of travel have changed. In this case, detailed mapping may be unavailable, and the vehicle has to navigate using real-time sensing of road features or obstacles using a computer vision system facilitated, for instance, by machine learning processes and feature detection models.

As shown in FIG. 1, the system 100 includes the learning system 101 and task API 107 for meta-reinforcement training of learning agent 103 according the various embodiments described herein. In one embodiment, the learning system 101, task API 107, and learning agent 103 have connectivity over a communication network 129 to the services platform 131 that provides one or more services 133 that can use asynchronous machine learning architectures and/or learning rules according to the embodiments described herein. By way of example, the services 133 may be third party services and include mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 133 use the output of the learning system 101 and/or learning agent 103 to provide services and applications.

In one embodiment, the learning system 101 may be a platform with multiple interconnected components. The learning system 101 may include multiple servers, intelligent networking devices, computing devices, components, and corresponding software for generating asynchronous learning rules and/or architectures. In addition, it is noted that the learning system 101 may be a separate entity of the system 100, a part of the one or more services 133, a part of the services platform 131, or included within the UE 123 or other client device, and/or the like.

By way of example, the IoT device 121 and/or UE 123 can be any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the IoT device 121 and/or UE 123 can support any type of interface to the user (such as “wearable” circuitry, etc.).

In one embodiment, the IoT device 121 and/or UE 123 may include or have connectivity to sensors for generating or collecting environmental image data (e.g., for processing by asynchronous learning rules and/or architectures generated according to the various embodiments described herein), related geographic data, etc. In one embodiment, the sensed data represent sensor data associated with a geographic location or coordinates at which the sensor data was collected. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

In one embodiment, the communication network 129 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the learning system 101, learning agent 103, task API 107, and other components of the system 100 communicate with each other using well known, new or still developing protocols. In this context, a protocol includes a set of rules defining how the network nodes within the communication network 129 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for generating asynchronous learning rules and/or architectures may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

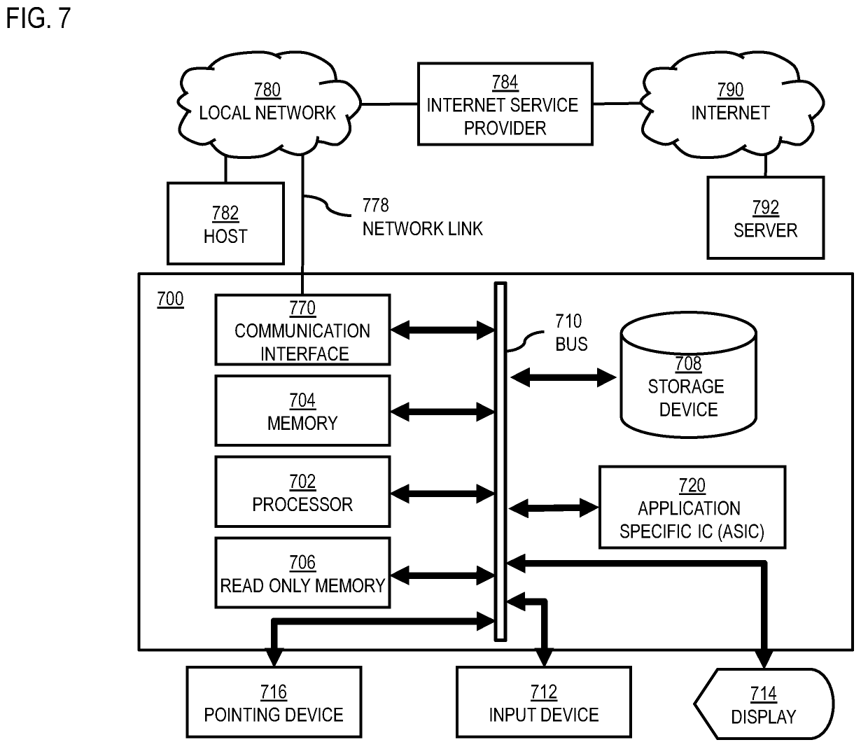

FIG. 7 illustrates a computer system 700 upon which an embodiment of the invention may be implemented. Computer system 700 is programmed (e.g., via computer program code or instructions) to generate asynchronous learning rules and/or architectures as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to generating asynchronous learning rules and/or architectures. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for generating asynchronous learning rules and/or architectures. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for generating asynchronous learning rules and/or architectures, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners, and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic, or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 129 for generating asynchronous learning rules and/or architectures.

The term computer-readable medium is used herein to refer to any medium that participates in providing information to processor 702, including instructions for execution. Such a medium may take many forms, including, but not limited to, non-volatile media, volatile media, and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to generate asynchronous learning rules and/or architectures as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to generate asynchronous learning rules and/or architectures. The memory 805 also stores the data associated with or generated by the execution of the inventive steps.

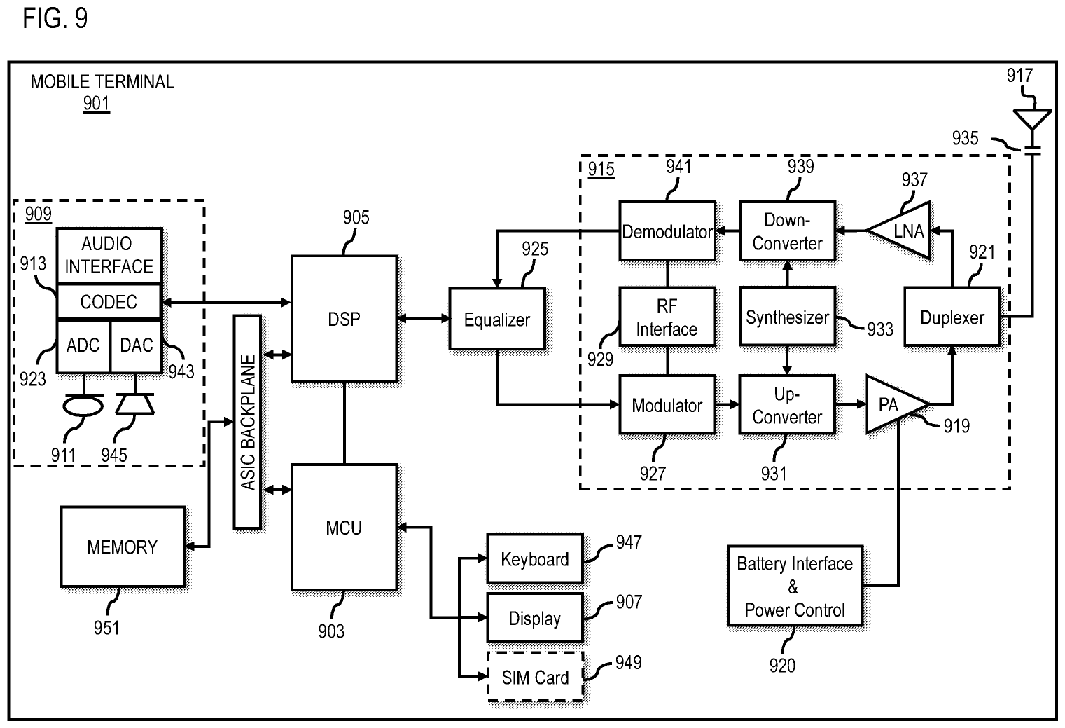

FIG. 9 is a diagram of exemplary components of a terminal device (e.g., an IoT device 121 or UE 123) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to generate asynchronous learning rules and/or architectures. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
configuring an asynchronous machine learning agent to learn based on one or more machine learning tasks, wherein the asynchronous machine learning agent includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected;
initiating a training of the asynchronous machine learning agent to learn an agent architecture, an agent learning rule, or a combination thereof based on the one or more machine learning tasks; and
configuring the plurality of the stateful neural units based on the agent architecture, the agent learning rule, or a combination thereof to perform a subsequent machine learning task.

2. The method of claim 1, wherein the plurality of stateful neural units are a plurality of neural units of a neuromorphic chip.

3. The method of claim 1, wherein the configuring of the asynchronous machine learning agent further comprises initiating a reset protocol to self-organize a topology of the plurality of stateful neural units.

4. The method of claim 3, wherein the reset protocol is initiated by transmitting a tensor signal encoded with a reset flag.

5. The method of claim 3, wherein the topology of the plurality of stateful neural units is self-organized by transmitting respective tensor signals indicating which of the plurality of stateful neural units are to act as one or more input neural units, one or more output neural units, one or more reward neural units, or a combination thereof during the one or more machine learning tasks.

6. The method of claim 1, wherein the agent architecture configures the plurality of stateful neural units as one or more input neural units, one or more output neural units, one or more reward neural units, or a combination thereof.

7. The method of claim 1, wherein the agent architecture configures one or more connections among the plurality of stateful neural units.

8. The method of claim 1, wherein the agent learning rule determines how a neural unit of the plurality of stateful neural units receives an input signal, performs neural processing on the input signal, modifies an internal state of the first neural unit, sends forward one or more output signals, or a combination thereof.

9. The method of claim 1, wherein the agent learning rule determines how much of a delay to introduce before sending forward one or more output signals from a neural unit of the plurality of neural units.

10. The method of claim 1, wherein the agent learning rule is applied symmetrically to the plurality of stateful neural units.

11. The method of claim 1, wherein the one or more machine learning tasks include a supervised learning task type, the method further comprising:
providing one or more supervised training examples as the one or more task inputs;
reading the one or more task outputs generated by the asynchronous machine learning agent based on the one or more supervised training examples; and
generating the one or more task feedback signals based on an error of the one or more task outputs.

12. The method of claim 1, wherein the one or more machine learning tasks include an unsupervised machine task type, the method further comprising:
providing training data as the one or more task inputs;
after a designated period of time, reading the one or more task outputs; and
generating the one or more task feedback signals based on the one or more task outputs.

13. The method of claim 1, wherein the one or more machine learning tasks include a reinforcement learning machine task type, the method further comprising:
providing training data and reward data as the one or more task inputs;
reading the one or more task outputs; and
generating the one or more task feedback signals based on the one or more task outputs and the reward data.

14. The method of claim 1, wherein the training of the asynchronous machine learning agent is optimized using reinforcement learning.

15. An apparatus comprising:
at least one processor; and
at least one memory including computer program code for one or more programs,
the at least one memory and the computer program code configured to, with the at least one processor, cause the apparatus to perform at least the following,
configure an asynchronous machine learning agent to learn based on one or more machine learning tasks, wherein the asynchronous machine learning agent includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected;
initiate a training of the asynchronous machine learning agent to learn an agent architecture, an agent learning rule, or a combination thereof based on the one or more machine learning tasks; and
configure the plurality of the stateful neural units based on the agent architecture, the agent learning rule, or a combination thereof to perform a subsequent machine learning task.

16. The apparatus of claim 15, wherein the plurality of stateful neural units are a plurality of neural units of a neuromorphic chip.

17. The apparatus of claim 15, wherein the configuring of the asynchronous machine learning agent further causes the apparatus to initiate a reset protocol to self-organize a topology of the plurality of stateful neural units.

18. A non-transitory computer-readable storage medium, carrying one or more sequences of one or more instructions which, when executed by one or more processors, cause an apparatus to perform:
configuring an asynchronous machine learning agent to learn based on one or more machine learning tasks, wherein the asynchronous machine learning agent includes one or more agent inputs for inputting one or more task inputs of the one or more machine learning tasks, one or more agent outputs for outputting one or more task outputs of the one or more machine learning tasks, one or more task feedback signals for scoring a performance on the one or more machine learning tasks, and a plurality of stateful neural units that are arbitrarily connected;
initiating a training of the asynchronous machine learning agent to learn an agent architecture, an agent learning rule, or a combination thereof based on the one or more machine learning tasks; and
configuring the plurality of the stateful neural units based on the agent architecture, the agent learning rule, or a combination thereof to perform a subsequent machine learning task.

19. The non-transitory computer-readable storage medium of claim 18, wherein the plurality of stateful neural units are a plurality of neural units of a neuromorphic chip.

20. The non-transitory computer-readable storage medium of claim 18, wherein the configuring of the asynchronous machine learning agent further causes the apparatus to perform initiating a reset protocol to self-organize a topology of the plurality of stateful neural units.
